(19) United States
(12) Patent Application Publication
(10) Pub. No.: US 2014/0298986 A1
(43) Pub. Date: Oct. 9, 2014

(54) PISTON ASSEMBLY

(71) Applicant: Thomas Blaszczykiewicz, Rochester, NY (US)

(72) Inventor: Thomas Blaszczykiewicz, Rochester, NY (US)

(21) Appl. No.: 14/192,815

(22) Filed: Feb. 27, 2014

Related U.S. Application Data
(60) Provisional application No. 61/770,269, filed on Feb. 27, 2013.

(51) Int. Cl. F16J 1/00

(52) U.S. Cl. CPC F16J 1/00
USPC 92/172; 29/888.041

(57) ABSTRACT

A piston assembly having a piston member with a removable wear sleeve and a method for removing and replacing the same having a center pin extending at least partially through the sleeve, a housing engaging the sleeve, and a mandrel engaging the center pin and the sleeve that may be removed to allow for the replacement of the sleeve while the piston member is in service.

### CROSS-REFERENCE TO RELATED APPLICATIONS

This patent application claims priority to co-pending U.S. Provisional Patent Application Ser. No. 61/770,269, filed on Feb. 27, 2013.

### TECHNICAL FIELD

The present novel technology relates generally to mechanical engineering, and more particularly, to a piston member having a removable wear sleeve and a method for removing and replacing the same while the piston member is in service.

### BACKGROUND

Compaction systems that utilize pistons or plungers as punchers to compress solids, fluids, or the like, are employed in various industries, such as industrial, oil and gas, core drilling and mining, compaction tooling and tableting equipment for the pharmaceutical industry, and power jet markets. During the compaction process, however, the application of significant compressive forces inevitably results in wear to the tips and heads of the punches. This force, associated friction and the nature of the materials being compacted, all combine to cause a high level of wear on the compaction tooling, resulting in the frequent need to change out and rework such tooling. Today, pistons are utilized for their limited life span, and are replaced with a brand new piston, manufactured with all new materials, labor and freight.

Although it is known to employ ceramics in the interior region of the die to reduce the wear from friction, easily replaceable or refurbishable tools such as compaction punches or pistons have not been successfully employed in a manner that allows the piston to be repaired on-site or through recyclable replacement parts and with minimal time in which the machine is down for repair. Furthermore, a method for quick and cost effective piston replacement/repair has not been successfully employed. Thus, there remains a need for quick and efficient replacement of punches in the field. The present novel technology addresses this need.

### BRIEF DESCRIPTION OF THE DRAWINGS

FIG. 1A is a side plan view of a piston assembly according to a first embodiment of the present novel technology.

FIG. 1B is a side cutaway view of the embodiment of FIG. 1A.

FIG. 1C is top plan view of the mandrel portion of the piston assembly embodiment of FIG. 1A.

FIG. 2A is a front perspective view of the embodiment of FIG. 1A.

FIG. 2B is a partial side cutaway elevation view of the embodiment of FIG. 1A.

FIG. 3 is a side cutaway elevation view of the embodiment of FIG. 1A.

### DESCRIPTION OF THE PREFERRED EMBODIMENTS

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

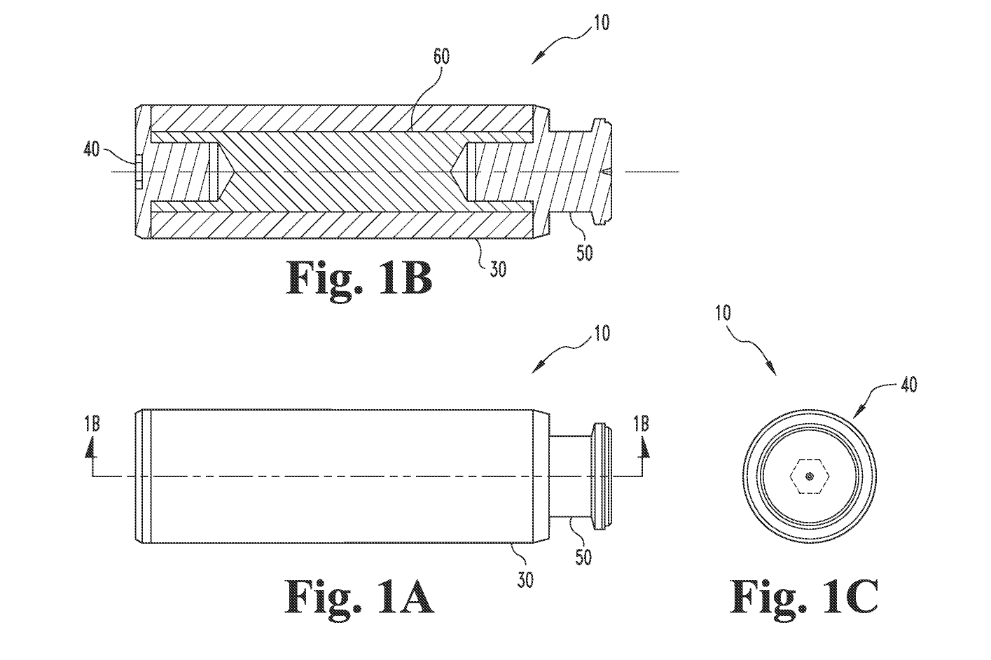

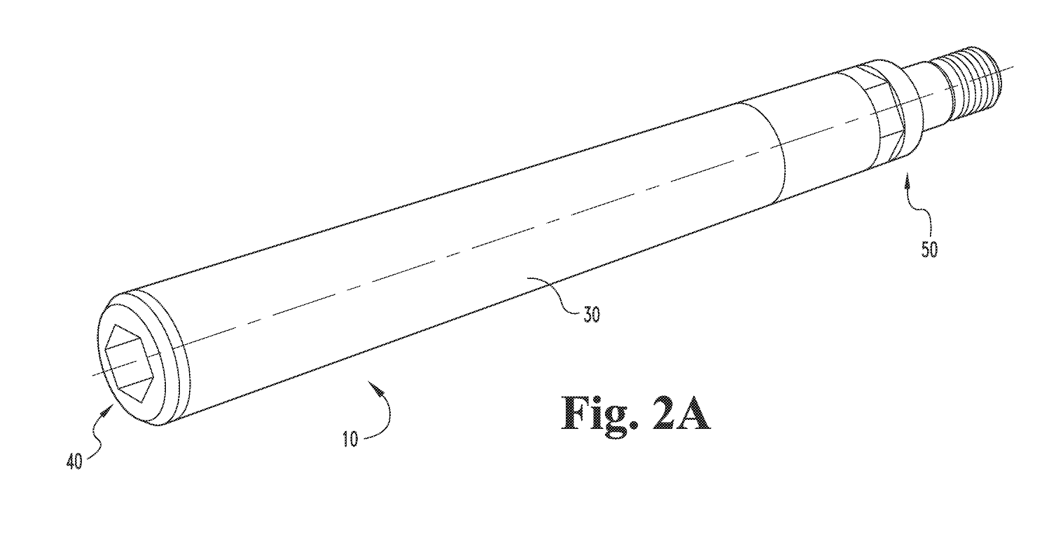

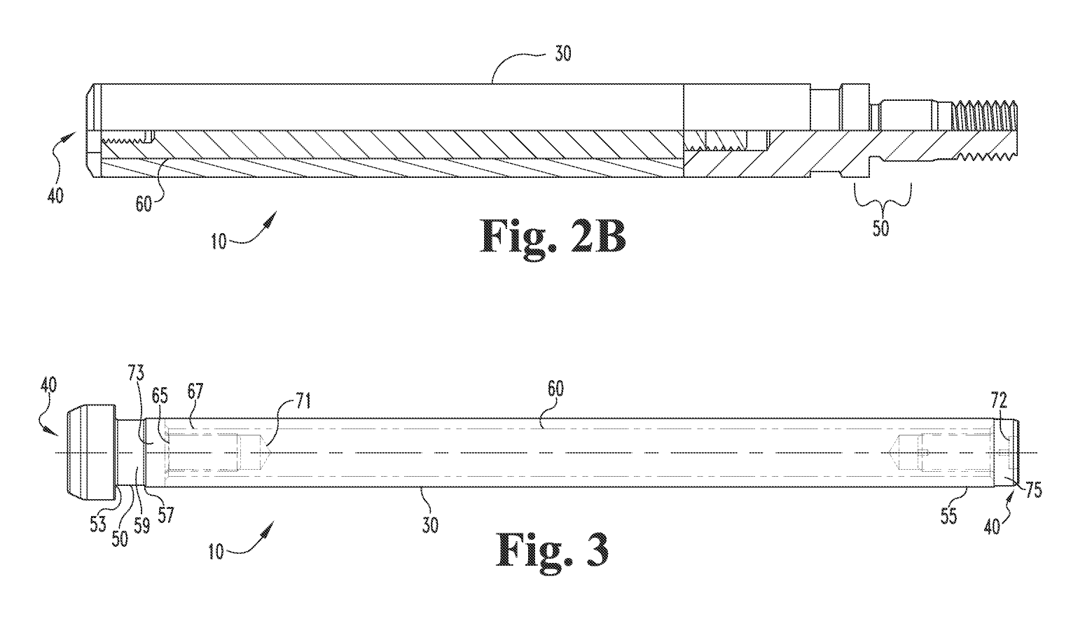

FIGS. 1A-3 illustrate a first embodiment of the present novel technology, a plunger piston assembly 10 typically utilized in pumps, motors or other systems that compress solids, fluids, or the like. The plunger piston assembly 10 generally includes a removable wear sleeve portion 30, a mandrel 40, a housing center 50, and a center pin 60. Previously, when a piston is worn due to significant compressive forces inherent in the compaction process, the piston 10 is discarded and the piston and various support components are replaced. The plunger piston assembly 10 allows for replacement of the components to quickly put the piston 10 back into service. This may be done multiple times before the piston assembly 10 has to be replaced with new parts. Therefore, the piston assembly 10 reduces the cost of raw materials, labor and transportation costs, as well as the amount of time the compaction machines are down for repair. The techniques described herein may be adapted to any of number of compaction tooling applications. In addition, the piston assembly 10 and replacement method may be used in other similar compaction embodiments to allow for the use and refurbishment of various materials, typically the ceramic sleeve 30, in high-friction environments. An advantage of the disclosed embodiments and methods is the reuse of a highly machined part instead of replacement of the same, wherein it is, only necessary to replace/refurbish the portion of the piston assembly 10 that is worn. As a result, the life of compaction tooling may be significantly increased and/or the cost of reworking and refurbishing the same may be reduced.

A piston/plunger assembly 10 generally contains a housing center 50, an elongated tubular body typically formed from a single piece of material, the body having a first end 53, a second end 55, an outer surface 57, and an inner surface 59 that defines a plunger receiving a center pin 60. The center pin 60, which is typically disposed inside the housing center 50, is typically made from a structural material, such as tool steel or pre-hardened steel, although various metals and possibly other materials may be employed and generally includes a first component or a center pin base 63, which is a generally cylindrical component having an aperture 65 in the lower end 67 thereof for controlling the position of the center pin 60, and/or affixing the mandrel 40 to the center pin 60, a ceramic tip 71 that forms the wear surface of the center pin assembly 60. The ceramic tip 71 is attached to the center pin base 73 using a mandrel arbor 75, typically made from tool steel, pre-hardened steel, or the like. As illustrated, mandrel arbor 75 is generally cylindrical, but typically includes either a tapered head at an upper end 77 thereof mated with tapered hole in ceramic tip 71, or a square head mated with counterbored hole in ceramic tip 71, so as to provide a positive engagement between mandrel arbor 75 and the ceramic tip 71.

In the known art, the housing 50, center pin 60, and mandrel 40 were typically permanently affixed in a manner that individual components of the piston/plunger 20 could not be removed or replaced. The piston/plunger assembly 10 permits the quick replacement of any of the piston/plunger components (the mandrel 40, a housing center 50, and a center pin 60) at any time, without having to tear apart the pump, through the use of a removable sleeve 30. The removable wear sleeve portion 30 is typically made of a structural ceramic material such as wear resistant ceramic oxides, although any convenient material may be selected, and is generally shaped and sized to snugly fit the dimensions of a standard piston/plunger 20, although the removable wear sleeve 30 may be sized and adapted to fit any piston/plunger. One such group of suitable wear resistant ceramic oxides is zirconia, which includes the species zirconium oxide, zirconium dioxide, tetragonal zirconia polycrystal (TZP), and partially stabilized zirconia (PSZ). Such partially stabilized zirconia may comprise stabilizers, e.g. yttria (Y₂O₃), magnesia (MgO), calcia (CaO), and ceria (CeO₂). A second group of suitable wear resistant ceramic oxides is alumina, also known as aluminum oxide (Al₂O₃) and corundum. A third group of suitable wear resistant ceramic oxides comprises mixtures of zirconia and alumina, including zirconia toughened alumina (ZTA), comprising between about 5 weight percent Zr₂O₃ and about 40 weight percent Zr₂O₃. In addition to ceramics, other materials are also suitable for the fabrication of a removable wear sleeve portion 30, and are to be considered within the scope of the present novel technology. For example, one may use a sleeve 30 comprised of e.g., silicon carbide, tungsten carbide, titanium nitride, or carborundum. In one further embodiment, a sleeve comprising a pre-hardened steel sleeve having a diamond impregnated surface may be used.

To assemble the plunger piston assembly 10, the center pin 60 is typically inserted into the removable wear sleeve 30. The housing center 50 is then attached to the center pin 60 and the mandrel 40 is then cinched down and connected to the center pin 60. This assembly 10 allows the piston/plunger 20 to be used until the piston/plunger is worn from use. Once the piston/plunger 20 is worn, the ceramic sleeve 30 may be removed by removing the mandrel 40 with a wrench, thus releasing the ceramic sleeve 30. A new ceramic sleeve 30 may then be placed onto the pre-existing mandrel 40 and cinched back onto the center pin 60. The use of such ceramic components enables reworking and replacement of the worn tool components. The easy to remove mandrel 40 allows for personnel in the field to easily remove the mandrel 40 and replace the worn ceramic or high wear sleeve 30 in the field. Alternatively, the plunger piston assembly 10 may be swapped out and sent back to the manufacturer to be refurbished and reused at a lower cost.

In operation, the removable wear sleeve 30 of the plunger piston assembly 10 may be replaced in the field, by first releasing the mandrel 40 from the center pin 60 through the use of a wrench or like device and then removing the worn or damaged high wear sleeve 30 from the piston assembly 10. Next, a new removable wear sleeve 30 is placed onto the pre-existing mandrel 40, and the mandrel 40 is then reattached back onto the center pin 60. Alternately, a component (such as the housing 50, or any other part) may be replaced in the field through a method, by first removing the piston 10 from service, and then disconnecting the mandrel 40 from the center pin 60. Next, the worn component (such as the housing 50) is removed from the piston assembly 10, and the worn component is replaced with a new or refurbished component. Finally, the mandrel 40 is reattached to the central pin 60.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

1. What is claimed is:
A piston assembly, comprising:
a ceramic sleeve having a first end and a second end;
a center pin extending at least partially through the sleeve;
a housing engaging the sleeve at the first end; and
a mandrel engaging the center pin and sleeve at the second end;
wherein the mandrel may be disengaged to allow removal and replacement of the sleeve.

2. A method of replacing a piston assembly, comprising:
a) releasing a mandrel from a center pin;
b) removing a worn sleeve from the piston assembly;
c) attaching a new sleeve to the piston assembly; and
d) attaching the mandrel back onto the center pin.
